(19) United States
(12) Patent Application Publication
(10) Pub. No.: US 2026/0098603 A1
(43) Pub. Date: Apr. 9, 2026

(54) SUPPORT-ROD HEAD STRUCTURE AND SUPPORT ROD

(71) Applicant: Tianjin Jinmao Household Products Co., Ltd, Tianjin (CN)

(72) Inventors: Fengming Li, Tianjin (CN); Yu Shen, Tianjin (CN); Jinlong Liu, Tianjin (CN); Longbo Li, Tianjin (CN)

(21) Appl. No.: 18/981,668

(22) Filed: Dec. 16, 2024

(30) Foreign Application Priority Data
Oct. 9, 2024 (CN) 202411402622.7

(51) Int. Cl. F16M 11/14

(52) U.S. Cl. CPC F16M 11/14; F16M 2200/028

(57) ABSTRACT

A support-rod head structure and a support rod are provided. The support-rod head structure includes a connecting base, a turning base and a top plate, wherein a top portion of the connecting base is provided with a first groove recessed downwards; the turning base is rotatably mounted in the first groove through a Y-direction pin shaft; the turning base is made from an elastic material, and has a top surface provided with a second groove; and a bottom surface of the top plate is fixed with a protruding rotating portion, wherein the rotating portion is detachably pressed into the second groove and rotates relative to the turning base. The support rod includes a telescopic rod and the preceding support-rod head structure, wherein a lower end of the connecting base is fixedly connected to a top end of the telescopic rod.

### CROSS-REFERENCE TO RELATED APPLICATION

The present disclosure claims the priority to the Chinese patent application with the filing No. CN2024114026227, filed on Oct. 9, 2024 with the Chinese Patent Office and entitled “SUPPORT-ROD HEAD STRUCTURE AND SUPPORT ROD”, the contents of which are incorporated herein by reference in entirety.

### TECHNICAL FIELD

The present disclosure relates to the field of construction tools, and in particular to a support-rod head structure and a support rod.

### BACKGROUND ART

In a construction environment, a support baffle cloth (blocking cloth, a common material of baffle cloth is plastic film) sometimes needs to be used to enclose and block a working area, so as to isolate a working area and a non-working area, protect workers and the public from potential danger in a construction area, control noise, dust and light in the construction area, and reduce influence of construction on surrounding environment.

In the prior art, a support rod for supporting a baffle cloth includes a telescopic rod and a head-end structure connected to a top portion of the telescopic rod. There are mainly two types of head-end structures.

The first type includes an upper clamping plate and a lower clamping plate, where a bottom portion of the lower clamping plate is connected to a top end of the telescopic rod through a universal joint, two gourd pin holes with consistent orientation are provided on the lower clamping plate, and two raised fixing pins are provided on a lower surface of the upper clamping plate. In use, the upper clamping plate and the lower clamping plate firstly need to be separated from each other, and then the baffle cloth (plastic film) is first placed above the lower clamping plate, then the upper clamping plate is placed above the baffle cloth, and the fixing pins of the upper clamping plate are inserted into large holes of gourd holes of the lower clamping plate, and the upper clamping plate is translated towards small holes of the gourd holes to be locked, so that an edge of the baffle cloth can be fixed to an end of the telescopic rod. The telescopic rod is then erected in a corridor or a room, so that an upper surface of the upper clamping plate faces a top wall (or a ceiling) of the corridor, the telescopic rod is extended until a “top-to-bottom (upright)” type support structure is formed. In the process, the universal joint is adapted to different angles of top walls of corridors. The support rod of this type of structure has defects of complex operation, and time and labor waste.

The second type includes an anti-slip top plate and a side clip. A bottom portion of the anti-slip top plate is provided with two connecting lugs, and the two connecting lugs are pivotally connected to two sides of a top end of a telescopic rod by screws. The side clip is fixed on a side surface of an upper end of the telescopic rod. In use, the baffle cloth is spread from a top portion of the anti-slip top plate and then clamped by the side clip, and then the telescopic rod is erected in a corridor or a room, so that an upper surface of the anti-slip top plate faces a top wall (or a ceiling) of the corridor, and the telescopic rod is extended until a “top-to-bottom” type support structure is formed. In the process, the anti-slip top plate can swing left and right relative to the telescopic rod so as to be adapted to different angles of top walls of corridors. Although the support rod of this type of structure is simpler to operate than that of the first type, it still has following defects: (1) as a clip is fixed on the side surface to clamp the baffle cloth, a connection structure of a universal joint is not suitable for use between the anti-slip top plate and the telescopic rod, and only the above swing-type pivotal structure can be used, while this structure has a limited adjustable range, which may cause that the anti-slip top plate cannot be in full contact with the top wall of the corridor, thus reducing support performance; and (2) when a part of the baffle cloth has been in contact with the top wall of the corridor, but angles of the anti-slip top plate and the top wall of the corridor are inconsistent, and the anti-slip top plate needs to be tilted towards a direction facing back to the clip so as to make them consistent, the side clip will limit a swingable amplitude of the anti-slip top plate relative to the telescopic rod, and when the amplitude is large, the baffle cloth is easy to slip from the clip, and it is also possible to damage the baffle cloth by pulling. In order to reduce occurrence of the above situations as far as possible, before the telescopic rod is jacked up, the anti-slip top plate needs to be adjusted, so that the angle of the anti-slip top plate is as close as possible to the angle of the top wall of the corridor, and then the telescopic rod is extended. However, even if adjustment is made in advance, the anti-slip top plate still may swing under the effect of a pulling force of the baffle cloth during jack-up, and the preceding problems (1) and (2) still will occur.

### SUMMARY

Embodiments of the present disclosure provide a support-rod head structure, including a connecting base, a turning base and a top plate, wherein a top portion of the connecting base is provided with a first groove recessed downwards, and the first groove extends through the connecting base in an X direction; the turning base is rotatably mounted in the first groove through a Y-direction pin shaft, and the turning base is configured to swing around the Y-direction pin shaft so as to go in and out of openings at two X-direction ends of the first groove in the X direction; the turning base is made from an elastic material, and has a top surface being provided with a second groove, wherein the second groove extends through the turning base in the X direction; and a bottom surface of the top plate is fixed with a protruding rotating portion, wherein the rotating portion is configured to be detachably pressed into the second groove and rotate relative to the turning base.

In one or more embodiments, the rotating portion is a rotating shaft, two opposite connecting lugs are provided at a bottom portion of the top plate, and the rotating shaft is mounted between the two connecting lugs.

In one or more embodiments, a top surface of the top plate is provided with an anti-slip protrusion.

In one or more embodiments, the anti-slip protrusion is configured to increase friction between the top plate and a baffle cloth.

Embodiments of the present disclosure further provide a support rod, including a telescopic rod and the support-rod head structure according to any one of the preceding embodiments, wherein a lower end of the connecting base is fixedly connected to a top end of the telescopic rod.

In one or more embodiments, the telescopic rod includes an outer rod, an inner rod, an elastic locking sleeve, a bottom compression rod and a spring assembly;
the lower end of the connecting base is fixedly connected to a top end of the inner rod;
the inner rod includes a cylindrical main body and an eccentric shaft rod which are integrally connected with each other; the elastic locking sleeve is sleeved outside the cylindrical main body; and the outer rod is sleeved outside the elastic locking sleeve, wherein the eccentric shaft rod and the outer rod are configured to rotate relative to each other, so that the eccentric shaft rod pushes the elastic locking sleeve to radially expand so as to tightly lock the outer rod and the cylindrical main body together;
the spring assembly is provided inside the outer rod, and includes an upper plug, a spring and a lower plug, wherein the upper plug abuts against a bottom portion of the eccentric shaft rod and is fixedly connected to an inner wall of the outer rod, the lower plug is fixedly mounted at a top end of the bottom compression rod, a top end of the spring is fixed to a bottom portion of the upper plug, and a bottom end of the spring is fixed to a top portion of the lower plug.

In one or more embodiments, a bottom surface of the upper plug is provided with a positioning groove, and the top end of the spring is inserted into the positioning groove.

In one or more embodiments, two ends of the outer rod are each provided with an end protecting sleeve, a diameter of a top end part of the lower plug is smaller than that of a bottom end part thereof, and an inner peripheral surface of the end protecting sleeve at a bottom end of the outer rod abuts on an outer peripheral surface of the bottom end part of the lower plug.

In one or more embodiments, a top end of the end protecting sleeve at the bottom end of the outer rod is inserted into the outer rod and fixedly connected to the inner wall of the outer rod.

In one or more embodiments, a bottom surface of the bottom compression rod is provided with an anti-slip sleeve.

In one or more embodiments, the lower end of the connecting base is provided with a mounting blind hole, and the top end of the inner rod is inserted into the mounting blind hole and then fixedly connected to the connecting base by a pin.

In one or more embodiments, the rotating portion is a rotating shaft, two opposite connecting lugs are provided in a bottom portion of the top plate, and the rotating shaft is mounted between the two connecting lugs.

In one or more embodiments, a top surface of the top plate is provided with an anti-slip protrusion.

In one or more embodiments, the anti-slip protrusion is configured to increase friction between the top plate and a baffle cloth.

### BRIEF DESCRIPTION OF DRAWINGS

In order to more clearly illustrate technical solutions in embodiments of the present disclosure or in the prior art, drawings which need to be used in the description of the embodiments or the prior art will be briefly introduced below. Apparently, the drawings in the following description merely show some embodiments of the present disclosure, and those ordinarily skilled in the art still could obtain other drawings in light of these drawings without using any inventive efforts.

FIG. 1 is a schematic axonometric view of a head-end structure of a first-type optional structure of a support rod for supporting a baffle cloth in the prior art;

FIG. 2 is a bottom view of a head-end structure of a first-type optional structure of a support rod for supporting a baffle cloth in an operation state in the prior art;

FIG. 3 is a front view of a head-end structure of a second-type optional structure of a support rod for supporting a baffle cloth in an operation state in the prior art;

FIG. 4 is a schematic view of an assembled state of a support-rod head structure provided in embodiments of the present disclosure;

FIG. 5 is a schematic view of a disassembled state of a support-rod head structure provided in embodiments of the present disclosure;

FIG. 6 is a first schematic view of an operation state of a support-rod head structure provided in embodiments of the present disclosure;

FIG. 7 is a second schematic view of an operation state of a support-rod head structure provided in embodiments of the present disclosure;

FIG. 8 is a sectional view of a support rod in a state of not being assembled with a top plate provided in embodiments of the present disclosure;

FIG. 9 is an enlarged view of a partial structure of region A in FIG. 8;

FIG. 10 is a radial sectional schematic view of an inner rod in FIG. 8; and

FIG. 11 is a schematic view of a spring in a compressed state in FIG. 8.

Reference signs: 100—baffle cloth; 200—telescopic rod; 210—upper clamping rod; 220—lower clamping plate; 230—universal joint; 240—gourd hole; 250—fixing pin; 300—anti-slip top plate; 400—side clip;
1—support-rod head structure; 11—connecting base; 110—first groove; 12—turning base; 120—second groove; 13—top plate; 131—anti-slip protrusion; 14—rotating portion; 141—connecting lug; 142—rotating shaft; 2—outer rod; 15—Y-direction pin shaft; 3—inner rod; 31—cylindrical main body; 32—eccentric shaft rod; 4—elastic locking sleeve; 5—bottom compression rod; 6—spring assembly; 61—upper plug; 62—spring; 63—lower plug; 7—end protecting sleeve; 8—anti-slip sleeve.

### DETAILED DESCRIPTION OF EMBODIMENTS

In order to make objectives, technical solutions and advantages of embodiments of the present disclosure clearer, the technical solutions in the embodiments of the present disclosure will be clearly and completely described in conjunction with drawings in the embodiments of the present disclosure. Apparently, only some but not all embodiments are described. Generally, components in the embodiments of the present disclosure described and shown in the drawings herein may be arranged and designed in various different configurations.

Therefore, the detailed description below of the embodiments of the present disclosure provided in the drawings is not intended to limit the scope of protection of the present disclosure, but merely represents chosen embodiments of the present disclosure. Based on the embodiments in the present disclosure, all of other embodiments obtained by those ordinarily skilled in the art shall fall within the scope of protection of the present disclosure.

It should be noted that like reference signs and letters represent like items in the drawings, and thus, once a certain item is defined in one drawing, it is unnecessary to further define and explain the same in subsequent drawings.

In the description of the present disclosure, it should be noted that orientation or positional relationships indicated by the terms such as “upper”, “lower”, “vertical”, “horizontal”, “inner”, and “outer” are based on orientation or positional relationships as shown in the drawings, or orientation or positional relationships of an inventive product when being conventionally placed in use, merely for facilitating describing the present disclosure and simplifying the description, rather than indicating or implying that a related device or element has to be in a specific orientation or configured and operated in a specific orientation; therefore, they should not be construed as limitation to the present disclosure. Besides, the terms such as “first”, “second”, and “third” are merely used for distinguishing the description, but should not be construed as indicating or implying importance in the relativity.

Besides, the terms “horizontal” and “vertical” do not mean that parts are required to be absolutely horizontal or overhanging, but may be slightly inclined. For example, by “horizontal” it merely means that a structure is more horizontal in comparison with “vertical”, rather than being completely horizontal, while the structure may be slightly inclined.

In the description of the present disclosure, it further needs to be indicated that unless otherwise specified and defined explicitly, the terms “provide”, “mount”, and “connect” should be construed in a broad sense. For example, it may be a fixed connection, a detachable connection, or an integrated connection; it may be a direct connection, an indirect connection through an intermediary, or inner communication between two elements. For those ordinarily skilled in the art, specific meanings of the above terms in the present disclosure could be understood according to specific circumstances.

In the prior art, a support rod for supporting a baffle cloth 100 includes a telescopic rod 200 and a head-end structure connected to a top portion of the telescopic rod 200. There are mainly two types of head-end structures.

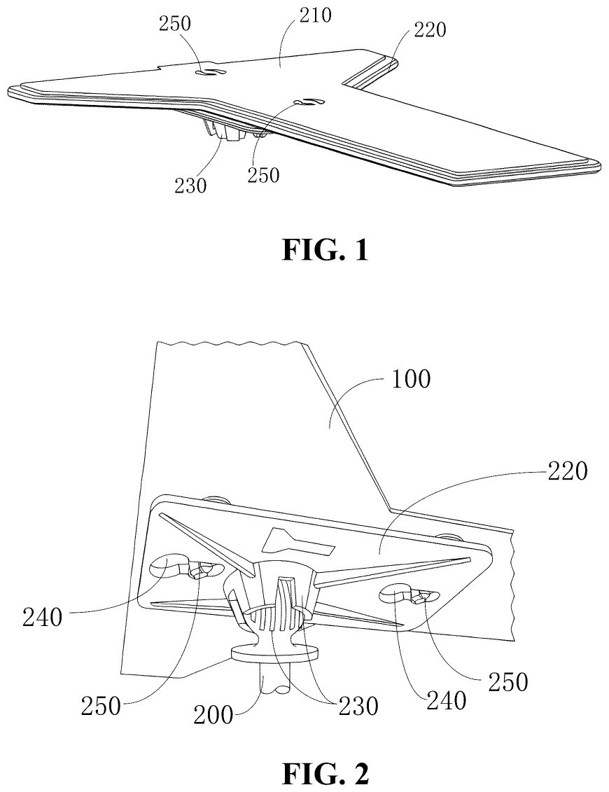

The first type, as shown in FIG. 1 and FIG. 2, includes an upper clamping plate 210 and a lower clamping plate 220, where a bottom portion of the lower clamping plate 220 is connected to a top end of the telescopic rod 200 through a universal joint 230, two gourd pin holes with consistent orientation are provided on the lower clamping plate 220, and two raised fixing pins 250 are provided on a lower surface of the upper clamping plate 210. In use, the upper clamping plate 210 and the lower clamping plate 220 firstly need to be separated from each other, and then the baffle cloth 100 (plastic film) is first placed above the lower clamping plate 220, then the upper clamping plate 210 is placed above the baffle cloth 100, and the fixing pins 250 of the upper clamping plate 210 are inserted into large holes of gourd holes 240 of the lower clamping plate 220, and the upper clamping plate is translated towards small holes of the gourd holes 240 to be locked, so that an edge of the baffle cloth 100 can be fixed to an end of the telescopic rod 200. The telescopic rod 200 is then erected in a corridor or a room, so that an upper surface of the upper clamping plate 210 faces a top wall (or a ceiling) of the corridor, the telescopic rod 200 is extended until a “top-to-bottom” type support structure is formed. In the process, the universal joint 230 is adapted to different angles of top walls of corridors. The support rod of this type of structure has defects of complex operation and time and labor waste.

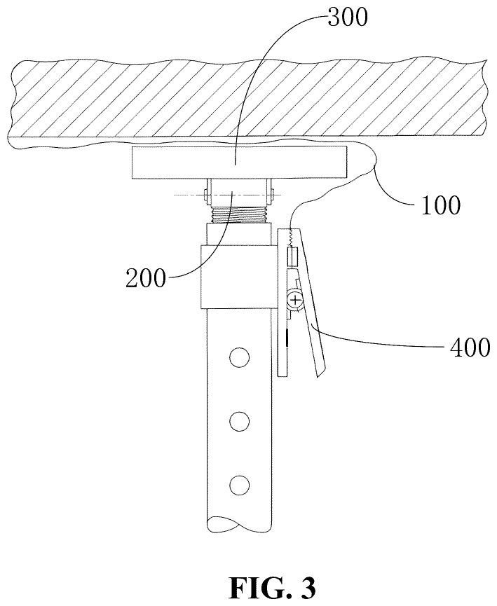

The second type, as shown in FIG. 3, includes an anti-slip top plate 300 and a side clip 400. A bottom portion of the anti-slip top plate 300 is provided with two connecting lugs 141, and the two connecting lugs 141 are pivotally connected to two sides of a top end of a telescopic rod 200 by screws. The side clip 400 is fixed on a side surface of an upper end of the telescopic rod 200. In use, the baffle cloth 100 is spread from a top portion of the anti-slip top plate 300 and then clamped by the side clip 400, and then the telescopic rod 200 is erected in a corridor or a room, so that an upper surface of the anti-slip top plate 300 faces a top wall (or a ceiling) of the corridor, and the telescopic rod 200 is extended until a “top-to-bottom” type support structure is formed. In the process, the anti-slip top plate 300 can swing left and right relative to the telescopic rod 200 so as to be adapted to different angles of top walls of corridors. Although the support rod of this type of structure is simpler to operate than the first type, it still has following defects: (1) as a clip is fixed on the side surface to clamp the baffle cloth 100, a connection structure of a universal joint 230 is not suitable for use between the anti-slip top plate 300 and the telescopic rod 200, and only the above swing-type pivotal structure can be used, while this structure has a limited adjustable range, which may cause that the anti-slip top plate 300 cannot be in full contact with the top wall of the corridor, thus reducing support performance; and (2) when a part of the baffle cloth 100 has been in contact with the top wall of the corridor, but angles of the anti-slip top plate 300 and the top wall of the corridor are inconsistent and the anti-slip top plate 300 needs to be tilted towards a direction away from the clip so as to make them consistent, the side clip 400 may limit a swingable amplitude of the anti-slip top plate 300 relative to the telescopic rod 200, and when the amplitude is large, the baffle cloth 100 is easy to slip from the clip, and it is also possible to damage the baffle cloth 100 by pulling. In order to reduce occurrence of the above situations as far as possible, before the telescopic rod 200 is jacked up, the anti-slip top plate 300 should be adjusted, so that the angle of the anti-slip top plate 300 is as close as possible to the angle of the top wall of the corridor, and then the telescopic rod 200 is extended. However, even if adjustment is made in advance, the anti-slip top plate 300 may still swing under the effect of a pulling force of the baffle cloth 100 during jack-up, and the preceding problems (1) and (2) still may occur.

In view of this, the present embodiment provides a support-rod head structure and a support rod, so as to solve the above technical problems.

Some embodiments of the present disclosure will be described in detail below in conjunction with the drawings. The following embodiments and features in the embodiments may be combined with each other without conflict.

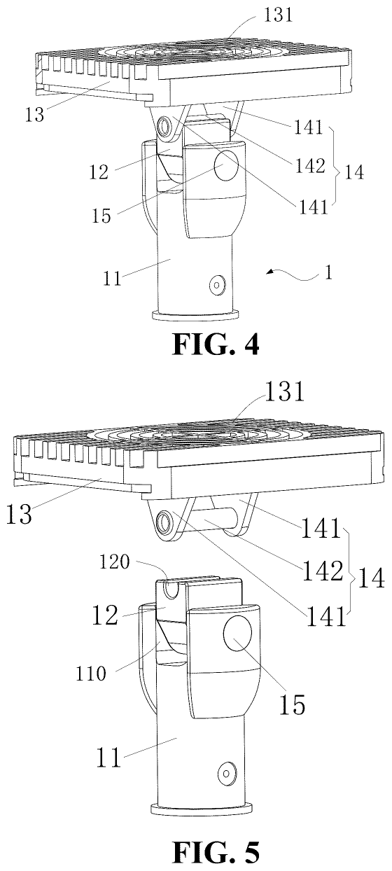

Embodiments of the present disclosure provide a support-rod head structure 1. Referring to FIG. 4 and FIG. 5, the support-rod head structure 1 includes a connecting base 11, a turning base 12 and a top plate 13. A top portion of the connecting base 11 is provided with a first groove 110 recessed downwards, and the first groove 110 extends through the connecting base 11 in an X direction. The turning base 12 is rotatably mounted in the first groove 110 through a Y-direction pin shaft 15, and the turning base 12 can swing around the Y-direction pin shaft 15 so as to go in and out of openings at two X-direction ends of the first groove 110 in the X direction. The turning base 12 is made from an elastic material, and has a top surface being provided with a second groove 120, where the second groove 120 extends through the turning base 12 in the X direction. A bottom surface of the top plate 13 is fixed with a protruding rotating portion 14, where the rotating portion 14 is detachably pressed into the second groove 120 and rotates relative to the turning base 12.

A specific usage mode thereof is as follows.

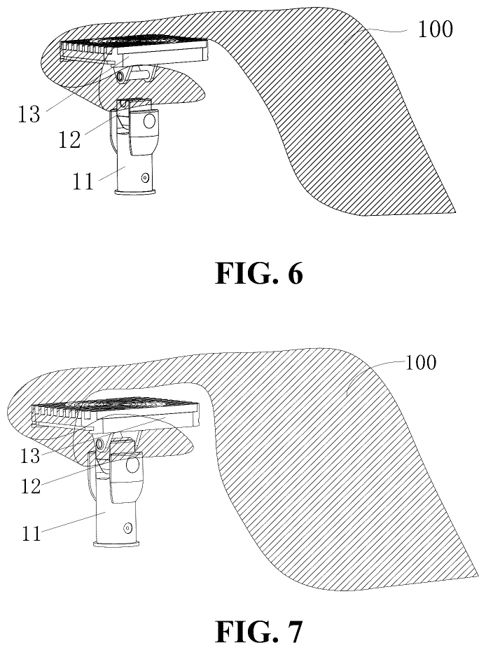

First, referring to FIG. 6, the rotating portion 14 of the top plate 13 is separated from the second groove 120 of the turning base 12, a baffle cloth 100 (plastic film or cloth of other materials) is laid on a top surface of the top plate 13 and passes downwards around the bottom surface of the top plate 13, so that a part of the baffle cloth 100 covers the rotating portion 14. Thereafter, referring to FIG. 7, the rotating portion 14 of the top plate 13 is pressed into the second groove 120 of the turning base 12 (the turning base 12, made from an elastic material, can be elastically deformed during pressing, and restore an initial state after the pressing so as to limit the rotating portion 14 of the top plate 13 in the second groove 120); in this case, the rotating portion 14 can rotate relative to the turning base 12, the turning base 12 can swing around the Y-direction pin shaft 15 so as to go in and out of the openings at two X-direction ends of the first groove 110 on the connecting base 11 in the X direction, and thus, the turning base 12, the connecting base 11 and the rotating portion 14 form the head structure having a composite function of “clip+universal joint”. After that, the support rod is erected in a corridor or a room, so that an upper surface of the top plate 13 faces a top wall (or a ceiling) of the corridor, and the support rod is extended until a “top-to-bottom” type support structure is formed. In the process, the top plate 13 can be adapted to different angles of top walls of corridors through the above head structure having the composite function of “clip+universal joint”.

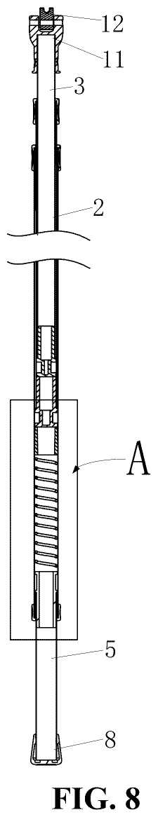

The support-rod head structure 1 provided in the present embodiment can be assembled with the telescopic rod 200 to form the support rod (referring to FIG. 8, a lower end of the connecting base 11 is fixedly connected to a top end of the telescopic rod 200), for supporting the baffle cloth 100 to enclose and block a working area during construction. Compared with the above two types of support rods in the prior art, the present embodiment at least has the following beneficial effects.

(1) The composite function of “clip+universal joint” that can only be realized by two groups of fittings in the prior art can be realized merely by one group of fittings, rotation of the universal joint is not affected by other fittings, and an adjustable angle range is wider.

(2) After the baffle cloth is fixed to the head structure, there is no need to adjust an angle of the top plate in advance, and the top plate is automatically attached to a contact surface during operation, thus the baffle cloth is not easy to slip off and is not damaged.

(3) There are fewer fittings, operations are easier and more convenient, and costs are lower.

In one or more embodiments, the above rotating portion 14 is a rotating shaft 142, two opposite connecting lugs 141 are provided in a bottom portion of the top plate 13, and the rotating shaft 142 is mounted between the two connecting lugs 141.

In one or more embodiments, the top surface of the top plate 13 is further provided with an anti-slip protrusion 131, so as to increase friction between the top plate 13 and the baffle cloth 100 and prevent the baffle cloth 100 from slipping off.

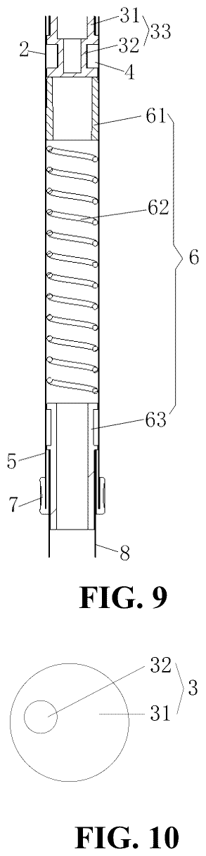

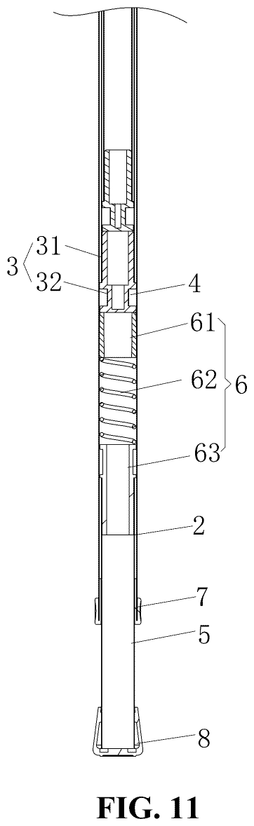

The present embodiment provides a support rod. Referring to FIG. 8 to FIG. 11, the support rod includes a telescopic rod 200 and the support-rod head structure 1 provided in the above embodiments. A lower end of the connecting base 11 of the support-rod head structure 1 is fixedly connected to a top end of the telescopic rod 200, where fixing manners include, but are not limited to, that a mounting blind hole is provided at the lower end of the connecting base 11, and the top end of the telescopic rod 200 is inserted into the mounting blind hole and then fixedly connected to the connecting base 11 by a pin.

Specifically, referring to FIG. 8 to FIG. 11, the telescopic rod 200 includes an outer rod 2, an inner rod 3, an elastic locking sleeve 4, a bottom compression rod 5 and a spring assembly 6. The lower end of the connecting base 11 is fixedly connected to a top end of the inner rod 3, where fixing manners include, but are not limited to, that a mounting blind hole is provided at the lower end of the connecting base 11, and the top end of the inner rod 3 is inserted into the mounting blind hole and then fixedly connected to the connecting base 11 by a pin. The inner rod 3 includes a cylindrical main body 31 and an eccentric shaft rod 32 which are integrally connected with each other. The elastic locking sleeve 4 is sleeved outside the cylindrical main body 31. The outer rod 2 is sleeved outside the elastic locking sleeve 4. The eccentric shaft rod 32 and the outer rod 2 are rotated relative to each other, so that the eccentric shaft rod 32 can push the elastic locking sleeve 4 to radially expand so as to tightly lock the outer rod 2 and the cylindrical main body 31 together. The spring assembly 6, provided inside the outer rod 2, includes an upper plug 61, a spring 62 and a lower plug 63. The upper plug 61 abuts against a bottom portion of the eccentric shaft rod 32 and is fixedly connected to an inner wall of the outer rod 2. The lower plug 63 is fixedly mounted at a top end of the bottom compression rod 5. A top end of the spring 62 is fixed to a bottom portion of the upper plug 61. A bottom end of the spring 62 is fixed to a top portion of the lower plug 63.

In use, when the inner rod 3 and the outer rod 2 of the telescopic rod 200 are adjusted to appropriate relative positions suitable for a height of a corridor, the support rod as a whole is slightly tilted and further extended for a length of 2-5 cm, and a rotating force in a horizontal direction is applied to the extended rod of the inner rod 3 and the outer rod 2 (the extended rod being a rod that is radially rotated and extended relative to the other rod), so that the eccentric shaft rod 32 pushes the elastic locking sleeve 4 to radially expand so as to tightly lock the outer rod 2 and the cylindrical main body 31 together. After that, a downward force parallel to a rod body is applied to the support rod, so that the bottom compression rod 5 compresses the spring assembly 6, the support rod is placed perpendicular to the ground while the support rod is being shortened, and after the top plate 13 is in contact with the top wall of the corridor, the spring assembly 6 rebounds, and the spring 62 provides a permanent support force. The telescopic rod 200 provided in the present embodiment is simple to operate and has an excellent supporting effect.

In one or more embodiments, a bottom surface of the upper plug 61 is provided with a positioning groove, and the top end of the spring 62 is inserted into the positioning groove, so as to improve stability of connection between the upper plug 61 and the spring 62.

In one or more embodiments, two ends of the outer rod 2 are each provided with an end protecting sleeve 7, a diameter of a top end part of the lower plug 63 is smaller than that of a bottom end part thereof, and an inner peripheral surface of the end protecting sleeve 7 at a bottom end of the outer rod 2 abuts on an outer peripheral surface of the bottom end part of the lower plug 63. In one or more embodiments, a top end of the end protecting sleeve 7 at the bottom end of the outer rod 2 is inserted into the outer rod 2 and fixedly connected to the inner wall of the outer rod 2.

In one or more embodiments, a bottom surface of the bottom compression rod 5 is further provided with an anti-slip sleeve 8.

Finally, it should be noted that various embodiments in the present description are described in a progressive manner. Each embodiment focuses on differences from other embodiments. For the same or similar parts between various embodiments, references can be made between each other. The above embodiments in the present description are only used to illustrate the technical solutions of the present disclosure, rather than limiting the same; although the present disclosure is described in detail with reference to various preceding embodiments, those ordinarily skilled in the art should understand that they still could make modifications to the technical solutions described in the various preceding embodiments or make equivalent substitutions to some or all of the technical features therein; these modifications or substitutions do not make essence of corresponding technical solutions depart from the scope of technical solutions of various embodiments of the present disclosure.

What is claimed is:

1. A support-rod head structure, comprising a connecting base, a turning base and a top plate,
wherein a top portion of the connecting base is provided with a first groove recessed downwards, and the first groove extends through the connecting base in an X direction;
the turning base is rotatably mounted in the first groove through a Y-direction pin shaft, and the turning base is configured to swing around the Y-direction pin shaft so as to go in and out of openings at two X-direction ends of the first groove in the X direction;
the turning base is made from an elastic material, and has a top surface provided with a second groove, wherein the second groove extends through the turning base in the X direction; and
a bottom surface of the top plate is fixed with a protruding rotating portion, wherein the rotating portion is configured to be detachably pressed into the second groove and rotate relative to the turning base.

2. The support-rod head structure according to claim 1, wherein the rotating portion is a rotating shaft, two opposite connecting lugs are provided at a bottom portion of the top plate, and the rotating shaft is mounted between the two connecting lugs.

3. The support-rod head structure according to claim 1, wherein a top surface of the top plate is provided with an anti-slip protrusion.

4. The support-rod head structure according to claim 3, wherein the anti-slip protrusion is configured to increase friction between the top plate and a baffle cloth.

5. A support rod, comprising a telescopic rod and the support-rod head structure according to claim 1, wherein a lower end of the connecting base is fixedly connected to a top end of the telescopic rod.

6. The support rod according to claim 5, wherein the telescopic rod comprises an outer rod, an inner rod, an elastic locking sleeve, a bottom compression rod and a spring assembly;
the lower end of the connecting base is fixedly connected to a top end of the inner rod;
the inner rod comprises a cylindrical main body and an eccentric shaft rod which are integrally connected with each other, the elastic locking sleeve is sleeved outside the cylindrical main body, and the outer rod is sleeved outside the elastic locking sleeve, wherein the eccentric shaft rod and the outer rod are configured to rotate relative to each other, so that the eccentric shaft rod pushes the elastic locking sleeve to radially expand so as to tightly lock the outer rod and the cylindrical main body together;
the spring assembly is provided inside the outer rod, and comprises an upper plug, a spring and a lower plug, wherein the upper plug abuts against a bottom portion of the eccentric shaft rod and is fixedly connected to an inner wall of the outer rod, the lower plug is fixedly mounted at a top end of the bottom compression rod, a top end of the spring is fixed to a bottom portion of the upper plug, and a bottom end of the spring is fixed to a top portion of the lower plug.

7. The support rod according to claim 6, wherein a bottom surface of the upper plug is provided with a positioning groove, and the top end of the spring is inserted into the positioning groove.

8. The support rod according to claim 6, wherein two ends of the outer rod are each provided with an end protecting sleeve, a diameter of a top end part of the lower plug is smaller than that of a bottom end part thereof, and an inner peripheral surface of the end protecting sleeve at a bottom end of the outer rod abuts on an outer peripheral surface of the bottom end part of the lower plug.

9. The support rod according to claim 8, wherein a top end of the end protecting sleeve at the bottom end of the outer rod is inserted into the outer rod and fixedly connected to the inner wall of the outer rod.

10. The support rod according to claim 6, wherein a bottom surface of the bottom compression rod is provided with an anti-slip sleeve.

11. The support rod according to claim 6, wherein the lower end of the connecting base is provided with a mounting blind hole, and the top end of the inner rod is inserted into the mounting blind hole and then fixedly connected to the connecting base by a pin.

12. The support rod according to claim 5, wherein the rotating portion is a rotating shaft, two opposite connecting lugs are provided in a bottom portion of the top plate, and the rotating shaft is mounted between the two connecting lugs.

13. The support rod according to claim 5, wherein a top surface of the top plate is provided with an anti-slip protrusion.

14. The support rod according to claim 13, wherein the anti-slip protrusion is configured to increase friction between the top plate and a baffle cloth.
